(19) United States
(12) Patent Application Publication
(10) Pub. No.: US 2009/0218518 A1
(43) Pub. Date: Sep. 3, 2009

(54) APPARATUS FOR CARRYING OUT REAL-TIME PCR REACTIONS

(75) Inventors: Andreas Schirr, Hamburg (DE); Gerd Eckert, Hamburg (DE); Markus Lapczyna, Hamburg (DE)

Correspondence Address: RANKIN, HILL & CLARK LLP, 38210 Glenn Avenue, WILLOUGHBY, OH, 44094-7808, US

(73) Assignee: EPPENDORF AG, Hamburg (DE)

(21) Appl. No.: 12/066,425

(22) PCT Filed: Sep. 1, 2006
(86) PCT No.: PCT/EP06/08559

§ 371 Date: Jul. 21, 2008

(30) Foreign Application Priority Data
Sep. 13, 2005 (DE) 10 2005 043 834.2

(51) Int. Cl. H05B 33/00

(52) U.S. Cl. 250/484.4

(57) ABSTRACT

Apparatus for carrying out real-time PCR reactions, including a thermocycler having a reaction region with a plurality of temperature-regulable receptacles for reaction vessels, an illumination device, which has a plurality of light-emitting diodes and is assigned to the reaction region and by means of which excitation light can be radiated into the receptacles, a detector device, which generates measured values in a manner dependent on a measured light intensity, optical devices defining a beam path that leads from the illumination device to the receptacles and from there to the detector device, a reference device, which generates a reference measured value by measurement of the light intensity of a light-emitting diode, and an evaluation device, which takes into account the reference measured value with the measured values, wherein the reference device has a reference light-emitting diode, the light of which is coupled into the beam path behind the reaction region.

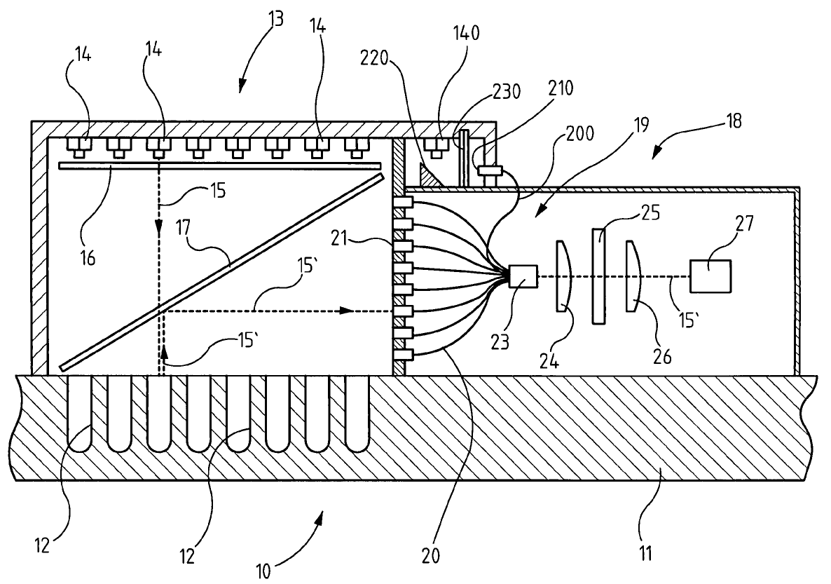

### BACKGROUND OF THE INVENTION

1. Field of the Invention

The invention relates to an apparatus for carrying out real-time PCR reactions.

2. Description of Related Art

Generic apparatuses used for carrying out nucleic acid amplification procedures (hereinafter called PCR reactions) measure the formation of the amplification products (PCR products) during the PCR reaction by optical means. This specific form of PCR is called real-time PCR.

It is common in real-time PCR reactions to carry out measurements on test samples that contain fluorescence indicators, which emit fluorescence signals after excitation whose intensity depends on the quantity of PCR product formed. Usually, the increase of PCR products with progressing reaction time can be followed in real-time PCR reactions by means of an increase in the intensity of the measured fluorescence signals.

A known example for a suitable fluorescence indicator is, e.g., the dye, Sybrgreen, which intercalates non-specifically into double-stranded DNA and emits a fluorescence signal in its intercalated state. There are a number of other suitable fluorescence indicators that are known to persons having skill in the art and shall not be discussed individually here. As a supplement, reference is made to the publication by “Neusser, Transkript Laborwelt no. 2/2000; “Echtzeit-PCR-Verfahren zur Quantifizierung von PCR-Produkten”” in which the different options of real-time PCR reactions are described in comprehensive detail.

Apparatuses that can be used to carry out real-time PCR reactions usually comprise a thermocycler having a reaction region with a plurality of temperature-regulable receptacles for reaction vessels. Further, there is provided an illumination device that is assigned to the reaction region and includes a plurality of light-emitting diodes, usually one diode for each receptacle. Further, there is provided a detector that generates measured values in a manner dependent on a measured light intensity. The detector can, for example, be or contain a CCD chip or a photo-multiplier.

The apparatus further includes suitable optical devices that define a beam path that leads from the illumination device to the reaction space and from there to the detector. The optical devices comprise, e.g., a dichroic mirror that is disposed between the illumination device and the receptacles and allows the excitation light emitted by the illumination device to pass to the receptacles and reflects, to the detector that is disposed, e.g., laterally, a fluorescence signal with a longer wavelength that is emitted from the reaction region. Usually, a number of other filters and lenses etc. are provided upstream of the detector.

One problem that is associated with known real-time PCR apparatuses is that variations of temperature or electrical current may interfere with the measurement. It is conceivable, e.g., that the excitation light generated by the light-emitting diodes is attenuated upon increasing time of operation or that the optical devices experience a drift when the apparatus is operated at different temperatures, to name but a few examples.

From WO 01/35079, it is known to provide, e.g. for standardization of the light-emitting diodes, a reference device that has a separate detector in the form of a photodiode that is used to measure the light-emitting diodes and to take into account the measured reference value with the sample measured value.

The known apparatus is disadvantageous in that the detector is not being tested.

From DE 20122266.3 it is known to provide in the apparatus, for compensation of possible thermal influences, if any, a reference beam path that extends analogous to the measuring beam path except that the light-emitting diode assigned to the reference beam path does not illuminate a PCR sample in a receptacle, but rather, e.g., a reference surface that can be placed onto a receptacle. The light reflected from this surface is analyzed by the detector, whereby changes during the PCR are used to correct the measured values. The apparatus is relatively resource-consuming.

### BRIEF SUMMARY OF THE INVENTION

It is the object of the invention to provide an apparatus that allows a possible drift of measured values, if any, to be recognized and compensated in simple fashion.

The object is met by an apparatus that includes a thermocycler having a reaction region with a plurality of temperature-regulable receptacles for reaction vessels, comprising an illumination device, which has a plurality of light-emitting diodes and is assigned to the reaction region and by means of which excitation light can be radiated into the receptacles, comprising a detector device, which generates measured values in a manner dependent on a measured light intensity, comprising optical devices defining a beam path that leads from the illumination device to the receptacles and from there to the detector device, comprising a reference device, which generates a reference measured value by measurement of the light intensity of a light-emitting diode, and comprising an evaluation device, which takes into account the reference measured value with the measured values, wherein the reference device includes a reference light-emitting diode, the light of which is coupled into the beam path behind the reaction region.

Accordingly, a reference device is provided in the apparatus, which reference device includes a reference light-emitting diode that is separate from the illumination device and whose light gets coupled into the beam path behind the reaction region.

Advantageous further developments of the invention include an apparatus wherein a diode whose emission spectrum is broader than that of the light-emitting diodes of the illumination device is provided as reference light-emitting diode, an apparatus wherein a diode generating white light is provided as the reference light-emitting diode, an apparatus wherein an optical filter device, in particular a neutral density glass filter, downstream from the reference light-emitting diode is provided, an apparatus wherein the light emitted by the reference light-emitting diode is coupled into the beam path by means of an assigned light conductor fiber and an apparatus wherein the reference light-emitting diode and the light-emitting diodes of the illumination device are connected to the same electrical power source.

Whereas essentially only a test of the light-emitting diodes used for measuring the PCR samples is performed in the known apparatuses, the invention uses a separate light-emitting diode in order to quantify and compensate possible drifts of measured values, if any, that are due to temperature variations and/or electrical power supply variations.

Advantageously, a diode whose emission spectrum is broader than that of the light-emitting diodes of the illumination device is used as reference light-emitting diode.

It is common to use in the illumination device diodes that generate, e.g., narrow-band blue light of a wavelength that is smaller than the detection wavelengths that is radiated at multipliers that are provided in the detector device. It is particularly advantageous to provide as the reference light-emitting diode a diode that generates broad-band white light. Using a reference light-emitting diode of this type, all multipliers can be irradiated directly at all filter settings of the detector device.

Differences in the temperature drift between blue and white diodes can be compensated reliably by means of additional temperature measurements. It has become evident that, e.g., blue, and white diodes also, show only very little temperature drift variations for a device of this type.

Obviously, it is also conceivable to use a reference light-emitting diode whose properties are identical to those of the light-emitting diodes of the illumination device. If one uses, e.g., a reference light-emitting diode that is identical to the light-emitting diodes in terms of its specification and operating conditions, it can be presumed that influences eliciting a drift of measured values in the light-emitting diodes have an identical effect in the reference light-emitting diode such that a direct compensation of the measuring results is feasible.

A further advantageous further development provides an optical filter device, in particular a neutral density glass filter, downstream from the reference light-emitting diode. The optical filter device can be used to set the intensity of the light emitted by the reference light-emitting diode to a desired intensity prior to coupling it into the beam path. It is common to select, e.g., a neutral density glass filter that sets the intensity such that, at medium detector sensitivity, an optimized reference signal reaches the multipliers, which signal is strong enough for a favorable signal-to-noise ratio and at the same time is not within the saturation region.

According to the invention, the coupling of the light of the reference light-emitting diode into the beam path is provided to occur behind the reaction space.

It is feasible within the scope of the invention to couple the light into the beam path at any place between reaction region and detector.

If one essentially desires to optimize the detector performance and/or the performance of a possibly provided multiplier with regard to possible drifts, it is then sufficient to couple the light, e.g., directly before the detector.

In contrast, if one desires to also take into account a possible drift of measured values that is due to optical devices upstream of the detector, the light of the reference light-emitting diode can be coupled into the beam path at an accordingly earlier point of the beam path.

It is conceivable to couple the light emitted by the reference light-emitting diode into the beam path by means of a mirror or other suitable optical devices, e.g. a light conductor that is assigned to the reference light-emitting diode.

The latter use of a light conductor is expedient in particular in those apparatuses whose optical devices include light conductors that are used to receive the fluorescence light that is emitted from the reaction space. In the process, the light entry surfaces of the light conductors, e.g., are each assigned to one receptacle, while the light exit surfaces are disposed in a bundled arrangement next to each other. In apparatuses of this type, it is easy to provide another light conductor whose light entry opening is assigned to the reference light-emitting diode and whose light exit opening is situated, in particular, amidst the other light conductors.

It is common in known apparatuses to excite and measure the receptacles each individually one after the other. In the process, a series of measuring runs proceeds for each PCR reaction, in which the receptacles and/or the samples that are present in the receptacles are measured. In the process, the reference light-emitting diode according to the invention can be switched-on with the same frequency and identical illumination time as the light-emitting diodes such that load and wear and tear are comparable. In this type of triggering, each measuring run can be compensated for a possible drift, if any. However, it has been evident that even only two reference measurements, one before and one after the PCR reaction, are sufficient.

Variations of the electrical power supply are a frequent cause of possible deviations of measuring results. For this reason, reference light-emitting diode and the light-emitting diodes of the illumination device are connected to the some electrical power supply in an advantageous further development such that all diodes are supplied with electrical power in an identical manner. Variations of the electrical power are set-off because the reference light-emitting diode is subject to the same influences in this further development.

### BRIEF DESCRIPTION OF THE DRAWINGS

The accompanying drawing FIGURE shows an exemplary embodiment of an apparatus according to the invention.

### DETAILED DESCRIPTION OF A PREFERRED EMBODIMENT

With reference to the accompanying drawing FIGURE, the apparatus 10 includes a thermocycler 11 that is shown schematically and includes receptacles 12. In operation, reaction vessels, in which one PCR sample each having the fluorescence indicator and/or the indicators mentioned above is contained and which are not shown here, are placed in the receptacles 12.

A lid housing 13 including an illumination device including a plurality of light-emitting diodes 14 is placed on the thermocycler 11. One light-emitting diode 14 each is assigned to one receptacle 12. Preferably, the light-emitting diodes 14 are arranged in the form of an array. During the measurement, the light-emitting diodes are preferably switched such that only one assigned receptacle 12 is irradiated at any given time.

An exemplary beam path is shown by 15, 15′. The light 15 is emitted by the light-emitting diode 14 and then passes first through a short pass filter 16 that is used to filter out long-wavelength fractions. Subsequently, the light 15 passes through a beam splitter 17, which is preferably completely permeable in this direction.

As has been mentioned repeatedly above, the light 15 emitted by the light-emitting diode 14 is meant to excite a fluorescence indicator that is present in a PCR sample in the receptacle 12, whereupon this fluorescence indicator emits a fluorescence signal 15′. The beam splitter 17 is structured such that the fluorescence signal 15′ is reflected towards the side.

Preferably, a dichroic mirror that allows the excitation light to pass, but reflects the fluorescence signal of a longer wavelength, is used as beam splitter 17.

The reflected fluorescence signal 15′ is then detected by a detector 27. Optical devices that can be used to display the fluorescence signal 15′ on the detector 27 are placed upstream of the detector 27. The detected signal is then amplified by one, usually a plurality of, e.g., wavelength-specific, multipliers that are not shown.

In detail, the optical devices comprise a number of light conductor fibers 20 that include light entry surfaces 21 that each are assigned to one receptacle 12 and/or to the fluorescence signals 15′ that are emitted from the receptacles 12 and reflected at the beam splitter 17.

The entry surfaces 21, in turn, are preferably disposed in the form of an array like the light-emitting diodes 14.

According to the invention, another diode is provided as reference light-emitting diode 140 in the lid housing in spatial proximity to the light-emitting diodes 14. The light generated by the reference light-emitting diode 140 is deflected towards the side by a mirror 220, then passes through a neutral density glass filter 230, and proceeds to a light entry surface 210 of a light conductor fiber serving as reference light conductor fiber 200. The mirror 220 can, e.g., be a ceramic mirror. The neutral density glass filter serves to set the intensity of the reference signal to a value that can be detected well.

The light conductor fibers 20 and the reference light conductor fiber 200 are combined into a bundle 23 at their exit end, whereby it is advantageous for the exit end of the reference light conductor fiber 200 to be disposed in the middle of the bundle 23 in order to minimize lateral radiation effects.

Providing for bundling has the effect that the signals from all receptacles 12 exit relatively close to each other. As has been mentioned above, the exit surface needs to be relatively limited in order to collimate the exiting light beams into a bundle whose directions of propagation differ only to a small extent. This is advantageous, in particular, if the downstream filters are interference filters whose spectral transmission characteristics depend on the angle of incidence onto the filter.

The fluorescence signal 15′ and the light of the reference light-emitting diode 140 are then displayed onto the detector 27 by the light conductor bundle 23 via further optical devices, e.g. a lens 24, a long pass filter 25, and another lens 26.

In the embodiment shown, a reference light-emitting diode can be provided and coupled into the beam path with relatively little design efforts.

1. An apparatus for carrying out real-time PCR reactions, comprising:
a thermocycler having a reaction region with a plurality of temperature-regulable receptacles for reaction vessels,
an illumination device, which has a plurality of light-emitting diodes and is assigned to the reaction region and by means of which excitation light can be radiated into the receptacles,
a detector device, which generates measured values in a manner dependent on a measured light intensity,
optical devices defining a beam path that leads from the illumination device to the receptacles and from there to the detector device,
a reference device, which generates a reference measured value by measurement of the light intensity of a light-emitting diode, and
an evaluation device, which takes into account the reference measured value with the measured values,
wherein the reference device includes a reference light-emitting diode, the light of which is coupled into the beam path behind the reaction region.

2. The apparatus according to claim 1, wherein a diode whose emission spectrum is broader than that of the light-emitting diodes of the illumination device is provided as the reference light-emitting diode.

3. The apparatus according to claim 2, wherein a diode generating white light is provided as the reference light-emitting diode.

4. The apparatus according to claim 1, wherein an optical filter device is provided downstream from the reference light-emitting diode.

5. The apparatus according to claim 1, wherein the light emitted by the reference light-emitting diode is coupled into the beam path by means of an assigned light conductor fiber.

6. The apparatus according to claim 1, wherein the reference light-emitting diode and the light-emitting diodes of the illumination device are connected to the same electrical power source.

7. The apparatus according to claim 4, wherein the optical filter device is a neutral density glass filter.
